(19) United States
(12) Patent Application Publication
(10) Pub. No.: US 2016/0203379 A1
(43) Pub. Date: Jul. 14, 2016

(54) SYSTEMS, METHODS AND DEVICES FOR THE AUTOMATED VERIFICATION AND QUALITY CONTROL AND ASSURANCE OF VEHICLE IDENTIFICATION PLATES

(71) Applicant: TigerIT Americas, LLC, Seattle, WA (US)

(72) Inventors: Sajjadul Hakim, Dhaka (BD); Asif Mahmood, Rajshahi (BD); Ziaur Rahman, London (GB)

(21) Appl. No.: 14/595,107

(22) Filed: Jan. 12, 2015

(51) Int. Cl. G06K 9/32; G06K 9/46; G06F 17/30; G06K 9/62

(52) U.S. Cl. CPC G06K 9/325; G06K 9/6201; G06K 9/4604; G06K 9/46; G06K 9/6215; G06K 9/4652; G06F 17/3028; G06K 2009/4666

(57) ABSTRACT

The present disclosure is directed towards systems, methods and devices for the automated verification, quality control and/or quality assurance of vehicle identification plates. Such verification and quality control/assurance of vehicle identification plates may include verifying information imprinted on a plate. In at least one embodiment, a method for verifying information imprinted on a plate includes capturing image data. The image data includes a plate region that corresponds to the plate. The method may also include generating a binary image based on the plate region and partitioning a portion of the first binary image into a sub-portion. A contour associated with the sub-portion is determined. The method also includes associating a matching template to the contour based on a comparison of the contour to a plurality of candidate templates and determining a portion of the information imprinted on the plate based on the associated matching template.

### FIELD OF THE INVENTION

The present disclosure relates to methods, techniques, devices and systems for automating the verification and quality control of the production of structures that include human readable text and, more particularly, to methods, techniques, devices and systems for automating the verification and quality control of the manufacture of vehicle identification plates.

### BACKGROUND OF THE INVENTION

In order to legally operate a vehicle, such as an automobile, truck, or motorcycle on a public road, a governing body typically requires a “tagging” of the vehicle. For instance, in many jurisdictions throughout the globe, a local governmental body requires the registration of the vehicle. The body may also require that the vehicle clearly and visibly display a license plate. The license plate includes one or more character strings that uniquely identify the vehicle, based on the registration of the vehicle.

A typical process for the validation and quality assurance of the manufacture, production, and/or personalization of license plates may involve printing a list of vehicle plate numbers that have been recently embossed and stamped on newly manufactured plates. A human manually matches the numbers on the list with the numbers imprinted on each of the plates. Because humans are prone to error when comparing lists of strings, a need exists to automate the verification and quality control of vehicle identification plates. It is for these and other concerns that the following disclosure is presented herein.

### SUMMARY OF THE INVENTION

The present disclosure is directed towards systems, methods and devices for the automated verification and quality control and/or quality assurance of vehicle identification plates. Such verification and quality control/assurance of vehicle identification plates may include verifying information imprinted on a plate. In at least one embodiment, a method for verifying information imprinted on a plate includes positioning the plate on a plate holder. A machine readable barcode may be scanned and/or read. Registration data based on the barcode may be retrieved from a computer device or a database. The method may include capturing image data. The image data may be captured with an image sensor that is coupled to the plate holder or frame. The image data includes a plate region that corresponds to the plate. The method may also include generating a binary image based on the plate region and partitioning a portion of the first binary image into a sub-portion. A contour associated with the sub-portion is determined. The method also includes associating a matching template to the contour based on a comparison of the contour to a plurality of candidate templates and determining a portion of the information imprinted on the plate based on the associated matching template.

In at least one embodiment, the method further includes generating a second binary image based on the image data. A largest rectangular contour included in the second binary image may be determined. The largest rectangular contour includes an aspect ratio within a predetermined aspect ratio range. The method may include determining the plate region based on the largest rectangular contour.

In various embodiments, the method further includes updating a size of the sub-portion based on a standard template size and partition the updated sub-portion into a plurality of tiles. The method includes generating a canvas image for each of the plurality of candidate templates based on a comparison between each of the plurality of tiles and a corresponding region in each of the candidate templates. A difference between each canvas image and the sub-portion may be determined. The matching template corresponds to a minimum difference of the determined differences.

In one embodiment, the method may further include determining a background color of the plate based on an average pixel value of the plate region and determining a plate size based on an aspect ratio of a largest rectangular contour included in the image data. Partitioning the portion of the first binary image includes partitioning the first binary image into a region sub-portion, a vehicle type sub-portion, and a plate number sub-portion. A portion of the determined information on the plate may include a conjunct character string.

In at least one embodiment, the method includes determining a sub-portion type of the sub-portion based on a location of the sub-portion within the first binary image and determining the plurality of candidate templates based on the sub-portion type. Furthermore, the determined information imprinted on the plate includes at least one of a region, a vehicle type, or a plate number encoded in a conjunct character string. The method includes comparing at least a portion of the determined information imprinted on the plate to information included in a database. The information may be retrieved based on the scanning or reading of a barcode or other optical information storage medium. The plate may be vetoed when the compared portion of the information imprinted on the plate does not correspond to the information included in the database.

Various embodiments of contents that are stored on computer-readable medium are disclosed herein. When at least some of the embodiments of the contents are executed by a computing system, various methods for facilitating verifying information imprinted on a plate are performed. Computing systems are also disclosed herein. Various embodiments of the computing systems include at least a processor device and a memory device. The computing system may include a module that is stored by the memory device. The module is configured such that when executed by the processor device, various methods for facilitating verifying information imprinted on a plate are performed.

Various methods may employ a webcam and a customized tool/frame that is vertically and horizontally adjustable. The frame may be a foldable frame that is provided in a small package to reduce shipping costs. The frame supports any conceivable image sensor. Various methods extract character s and/or patterns, including, but not limited to conjunct fonts from reflective surfaces under indoor lighting conditions, various color contrasts, and/or from images data captures at various angles.

The various embodiments may detect and match number plates that have textual characters on a plurality of vertical columns or a plurality of horizontal lines. The plates may be different sizes and colors. The quality assurance process is automated to the extent that the process requires minimal human interaction. The characters may be embossed and/or hot-stamped. The results of a quality assurance process may be presented to a user, such as being printed on a screen. The user may be enabled to click a button to accept or reject plate based on the quality assurance results.

### BRIEF DESCRIPTION OF THE DRAWINGS

Preferred and alternative examples of the present invention are described in detail below with reference to the following drawings:

FIG. 1 illustrates an example embodiment of a vehicle identification plate that includes conjunct characters.

FIG. 2 illustrates an example block diagram of a vehicle identification plate embossing and stamping system and process according to an example embodiment.

FIG. 3 is an example block diagram of an overall verification and quality assurance process for a vehicle identification plate according to an example embodiment.

FIG. 4 is an example embodiment of an overall workflow for the automatic verification and quality assurance for a vehicle identification plate consistent with the various embodiments disclosed herein.

FIG. 5 is an example process for detecting an image and/or image information from image data that is consistent with various embodiments describe herein.

FIG. 6 is an example process for recognizing a detected image and/or image information from image data that is consistent with various embodiments describe herein.

FIG. 7 is an example process for matching recognized image and/or image information that is consistent with various embodiments describe herein.

FIG. 8A illustrates a captured image of a license plate to be verified for quality assurance.

FIG. 8B illustrates a binary image based on the captured image of FIG. 8A after an adaptive threshold technique has been applied.

FIG. 9A illustrates a determined largest rectangular contour for the image data of FIG. 8A.

FIG. 9B illustrates the four boundary points of the rectangular contour of FIG. 9A.

FIG. 9C illustrates image data of the binary image of FIG. 8B after a global threshold technique has been applied.

FIGS. 9D-9E illustrate various sub-portions of the image of FIG. 9C.

FIGS. 10A-10G illustrate various embodiments of sub-portions of a binary image of a license plate region.

FIGS. 11A-11C illustrate various inner contours based on sub-portions of a binary image of a license plate region.

FIGS. 11D-11E illustrate the generation of various canvas images based on a comparison of contours extracted from a vehicle type sub-portion of image data and candidate matching templates.

FIGS. 12A-12B illustrates the generation of various canvas images based on a comparison of contours extracted from a region/jurisdiction sub-portion of image data and candidate matching templates.

FIGS. 13A-13B illustrate the generation of various canvas images based on a comparison of contours extracted from a license plate digit sub-portion of image data and candidate matching templates.

FIGS. 14A-14C illustrate an example embodiment of a stabilizing frame specially adapted to enable the capturing of image data.

FIGS. 15A-15C illustrate a folding base sub-assembly included in the stabilizing frame of FIGS. 14A-14C.

FIGS. 16A-16C illustrate a telescoping platform included in the stabilizing frame of FIGS. 14A-14C.

FIG. 17 is an example block diagram of an example computing system for implementing a location-based recommendation system according to an example embodiment.

### DETAILED DESCRIPTION OF THE PREFERRED EMBODIMENT

The system, method and device embodiments disclosed herein enable the automated verification and quality control of the manufacture, production, and/or personalization of structures that include human readable character strings. Embodiments herein are discussed in the context of the verification and quality control of vehicles license plates. However, it should be appreciated that the embodiments are not limited to such applications, and may be employed in any context where strings of characters are compared.

License plates are produced in many jurisdictions around the world and it should be recognized the various embodiments herein may be employed in any license plate production facility anywhere in the world. Furthermore, the embodiments are not limited by the various characters, alphabets, languages, symbols, color schemes, font styles and sizes and the like employed in the many jurisdictions. For instance, various embodiments may be employed with equal success on conjunct and non-conjunct fonts alike.

Briefly stated, upon the manufacturing of a license plate, image data of the license plate is captured. The image data is automatically processed and analyzed to verify the quality, fidelity, accurateness and/or the precision of the information included on the license plate. For instance, the automated analysis determines the size, type, and background color of the license plate. Additionally, by employing various embodiments, the characters strings embossed on the license plate are optically recognized to determine the textual information included on the license plate. The results of the analysis are automatically compared to the attributes, qualities and/or tolerances that are the goal of the manufacturing process. If the manufactured license plate does not meet a predetermined criteria, accurateness threshold, quality, and/or the textual information embossed on the license plate cannot be verified, the license plate under analysis is flagged. In various embodiments, the license plate is discarded and manufactured again. These methods also enable the collection of statistical data regarding the yield and/or quality of the manufactured licenses plates at the facility or operator level.

The preferred embodiments described herein are especially adapted to the accurate recognition of conjunct character strings, although the methods will accurately recognize non-conjunct characters also. One reason for the success of the recognition of conjunct character strings of the various embodiments is the utilization of predetermined templates employed in the recognition and matching methods described herein. Because the information/data embedded in license plates is highly structured, templates may be utilized to recognize the expected structure of the license plate. Additionally, the employment of predetermined templates decreases the search space required to recognize and match character strings embossed on the manufactured license plates, improving both the accuracy and the efficiency of the matching and recognition methods. The verification and quality assurance of Bangladesh license plates are discussed herein as exemplary embodiments of a highly structured license plate, as well as predetermined templates used to match conjunct textual information. However, it should be recognized that these methods are not constrained to Bangladesh license plates, but are generalizable to any license plate with a known structure.

The embodiments described herein successfully deal with numerous factors that would otherwise limit the ability to verify and/or perform quality assurance on license plates. For instance, pattern recognition may be difficult when words or characters in a language script are conjunct and contain punctuations placed on different sides of an intended character. The phrase “Dhaka Metro—Ga” would appear in Bengali as “ [symbol] .” As can be seen from this Bengali transcript above, the letters are highly connected where even two or more letters are joined together to form a syllable.

Additionally, the surfaces of embossed license plates are not flat, but rather include three-dimensional structures that are rendered in two-dimensions within image data. The surface or platform that the font is read from has an effect on the pattern recognition process as well. In addition, vehicle license plates have retro-reflective surfaces that often distort the image data. The contrast between the surface color and the font color affects many pattern recognition schemes. As described herein, a transformation of the image data to binary data successfully overcomes these issues. Because of these transformations, the embodiments herein successfully analyze license plates of any background and font color combination, including green, black, blue, red, yellow, white, or any combination thereof.

Bangladesh license plates are available in three sizes: small, medium and large. The embossed font size plate may depend upon the information included in the text to be embossed. For instance, on small plates, when words that include long character strings are embossed, the font size may be decreased to adequately position the embossed pattern on the plate surface. Typically, the smaller the font size, the more difficult it is to successfully recognize the characters. As described herein, resizing the image data to match corresponding template sizes enables the recognition of characters of varying font sizes.

The lighting conditions of the ambient environment from which the image data was captured in often affects the quality of the image data. Factors such as sunlight, room environment, adequate lighting and intensity of the source of light all affect the quality of the image data. As described herein, the various embodiments adequately overcome these and other factors to automatically, accurately, and precisely analyze the quality of a manufactured license plate.

### Embodiments for the Automated Verification and Quality Assurance of a Vehicle Identification Plate

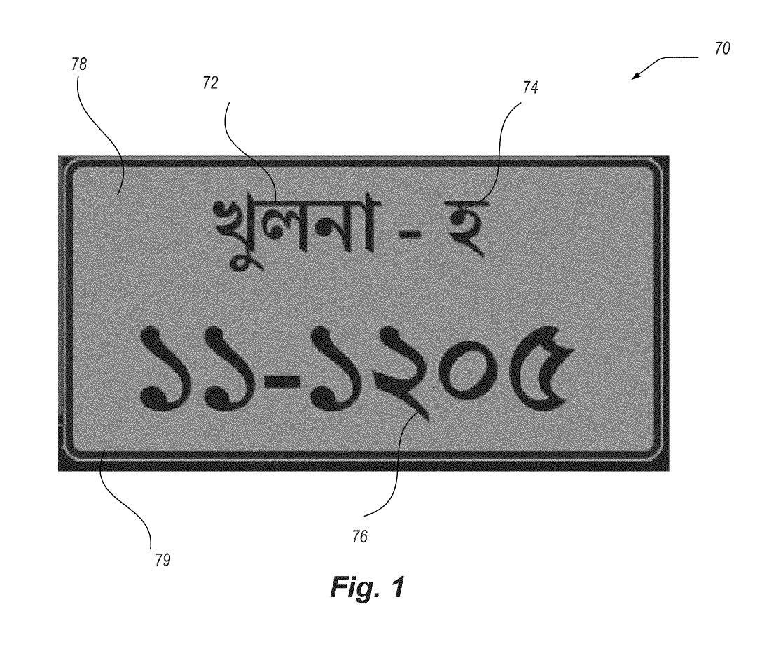

FIG. 1 illustrates an example embodiment of a vehicle identification plate (VIP) 70 that includes conjunct characters. In various embodiments, VIP 70 is a vehicle license plate. One exemplary jurisdiction where the systems, methods and devices may be employed is Bangladesh, although the embodiments may be employed in virtually any jurisdiction throughout the world. The vehicle number plates in Bangladesh come in one of two background colors: green and white. A license plate with a green background signifies commercial and public transportation vehicles, wherein a white background signifies privately owned vehicles. VIP 70 includes green (dark) background 78.

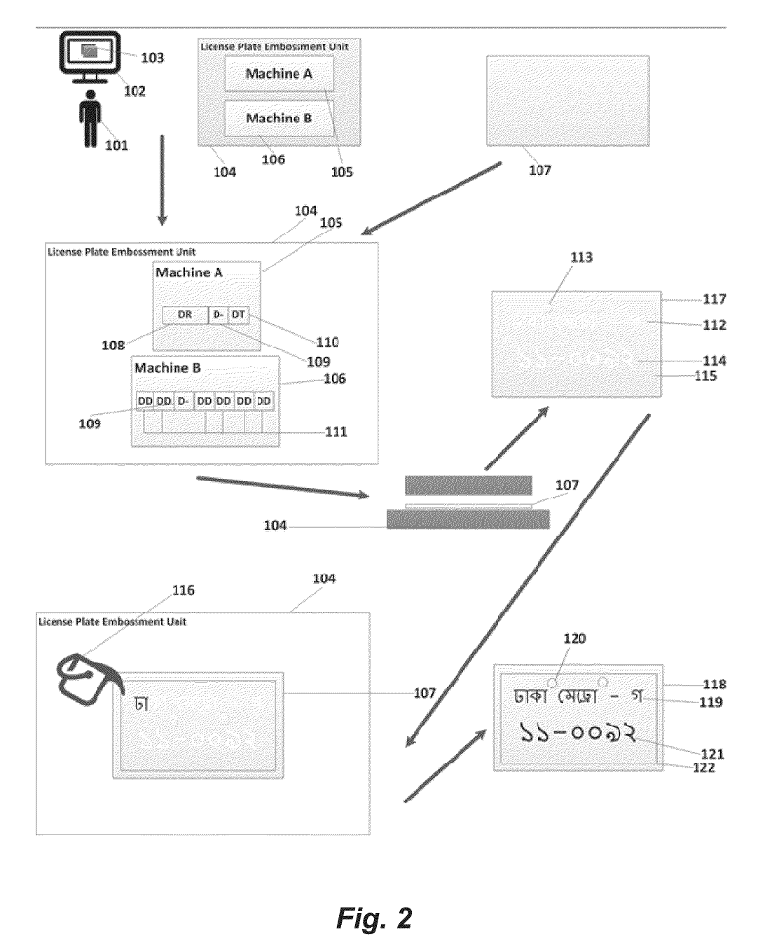

VIP 70 includes conjunct Bengali characters. The vehicle registration or identification number (IDN) uniquely identifies the jurisdiction or region, the vehicle class or type, and the vehicle. The IDN is distributed over two horizontally oriented character lines, rather than a single line as in many other jurisdictions. The upper IDN line includes two character fields, separated by a hyphen “-” character. Region character field 72, or cub-portion, includes characters that identify the region; in this case, the conjunct characters translate to “Dhaka Metro,” which is one of the regions within Bangladesh. The vehicle type field 74, or sub-portion, signifies a “J” type vehicle class. The lower IDN field is a vehicle identification field (VID) 76, or sub-portion, that identifies the vehicle as “11-0092.” There is a black border 79 around both the number plates and the text that is hot stamped in black, as described in the context of FIG. 2.

Embodiments disclosed herein provide systems, methods and devices to ensure the automated verification and quality control of vehicle plates during personalization and embossing with minimal human intervention. Accomplishing the automated quality control and validation process under discussion includes the detection, extraction and matching of conjunct fonts and patterns from the retro-reflective surfaces under indoor lighting conditions.

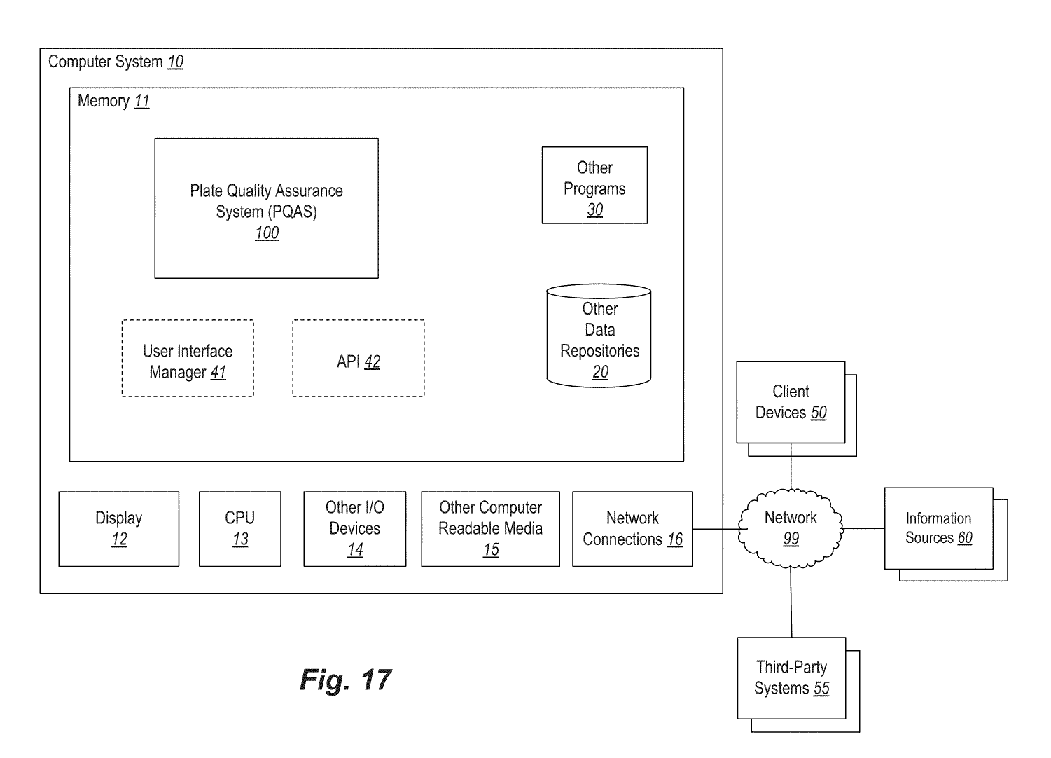

FIG. 2 illustrates an example block diagram of a vehicle identification plate embossing and stamping system and process according to an example embodiment. The system shown in FIG. 2 includes computer device 102. Computer device 102 may be a client device, such as a desktop computer, a laptop, or a mobile device. Computer device 102 may be included in the computer system 10 described in the context of FIG. 17. The process illustrated in FIG. 2 embosses and stamps vehicle identifying character strings, such as those described in the context of FIG. 1, on blank plate 107. At least some of the plates generated and/or manufactured by the system illustrated in FIG. 2 are retro reflective license plates.

Each blank plate 107 includes a machine-readable barcode. During the embossing and/or stamping process, the registration details are associated with the machine-readable barcode. The association may be stored on a computer device, such as a server device. During an overall quality assurance and/or verification process, the system reads the bar code from the plate and retrieves registration details. The system may retrieve the registration data from a remote or local computer device, such as a server device. Based on the retrieved registration data, the system determines the plate's size and color. At least a portion of this information is displayed on a display screen associated with client device 102, such as display 12 of FIG. 17. A user 101 of client device 102 may manually verify the color and size for the retrieved registration data.

As discussed above, user 101 validates the manufactured license plates with the standards and parameters determined by the system. Client device 102 executes a license plate quality assurance (QA) client program 103. QA client program 103 includes a graphical user interface (GUI) that provides a visual representation of the look and feel of the next license plate to be constructed. QA client program 103 may be included in a Plate Quality Assurance System (PQAS), such as PQAS 100 of FIG. 17.

The plates are embossed and/or personalized based on the retrieved registration data, by employing license plate embossment unit 104. Embossment unit 104 embosses characters on blank plate 107, colors the font and borderline of plate 107, and creates vehicle mounting apertures or hole to plate 107. Embossment unit 104 includes two sub-units: Machine A 105 and Machine B 106. In preferred embodiments, Machine A 105 and Machine B 106 are separate sub-units. In other embodiments, Machine A 105 and Machine B 106 are included in a single machine. Machine A 105 embosses a region character field, such as region character field 72 of FIG. 1, a “-” character, and a vehicle type field, such as vehicle type field 74 of FIG. 1, on the top portion of plate 107. Machine B 106 embosses a vehicle identification field, such as VID field 76 of FIG. 1. In preferred embodiments, the VID field includes at least six conjunct characters and an inner “-” character on the bottom portion of the license plate 107.

At the beginning of the embossing process illustrated in FIG. 2, the system determines the next registration to be printed based on a pre-configuration performed by an administrator. During the pre-configuration, the administrator inputs what category of plates should be displayed to which particular embossing machine. Client device 103 displays a visual preview of the next plate to be printed. When displaying the next configuration, the system provides priority to records that are marked as urgent. This ensures that during the embossing process, minimal or no human intervention is required to push registrations to computing devices of the embossing machines 105, 106. User 102 may verify the information provided by the visual display. In addition to other information regarding the plate to be printed or embossed, client device 103 provides user 101 with plate dimensions, characters, character size, font style and color, color of license plate, positions of the holes to be punctured, and the like. Based on at least one of registration data and embossing requirements retrieved by client device 103, operator 101 positions corresponding embossing dice in Machine A 105 and Machine B 106. Character sizes on the positioned dice correspond to the size of the plate.

Region character dice 108, the “-” character dice 109, and vehicle type character dice 110 are schematically shown positioned in Machine A 105 and Machine B 106. In embodiments where region name has two or more separate words, two or more separate instances of region character dice 108 are positioned within Machine A 105. With appropriate choices for dice 108, 109 and 110 positioned within Machine A 105, Machine A 105 embosses the upper portion of plate 107 with characters that signify the region and vehicle type. In an analogous way, six instances of numerical dice 111 and “-” character dice 109 are positioned within Machine B 106 to emboss the VID on the lower portion of plate 107.

Next, plate 107 is placed inside embossment unit 104 for embossing. The machine-readable barcode is scanned so that the system may associated plate 107 with the registration details. Embossment unit 104 stamps downward on plate 107, so that the characters corresponding to dice 108, 109, 110 and 111 are embossed onto plate 107. View 117 provides a sample view of plate 107 after the characters are embossed and holes/apertures are punctured. Upper character line 112 shows the embossed characters for the region, “-” character and the vehicle type. Apertures 113 are punctured on the license plate 107 to enable mounting the plate on a vehicle. Apertures may be punctures in additional and/or alternative locations on plate 107. Lower character line 114 shows the embossed characters of the six digits and “-” character used to identify the vehicle. Embossed plate border 115 is also illustrated in view 117.

The next step is hot stamping process 116 that is applied on the plate shown in view 117. Hot stamping process 116 applies color to upper character line 112, lower character line 114 and border 115. Inaccuracies in font size may damage hot stamping process 116 and character background may receive the same color or no color at all.

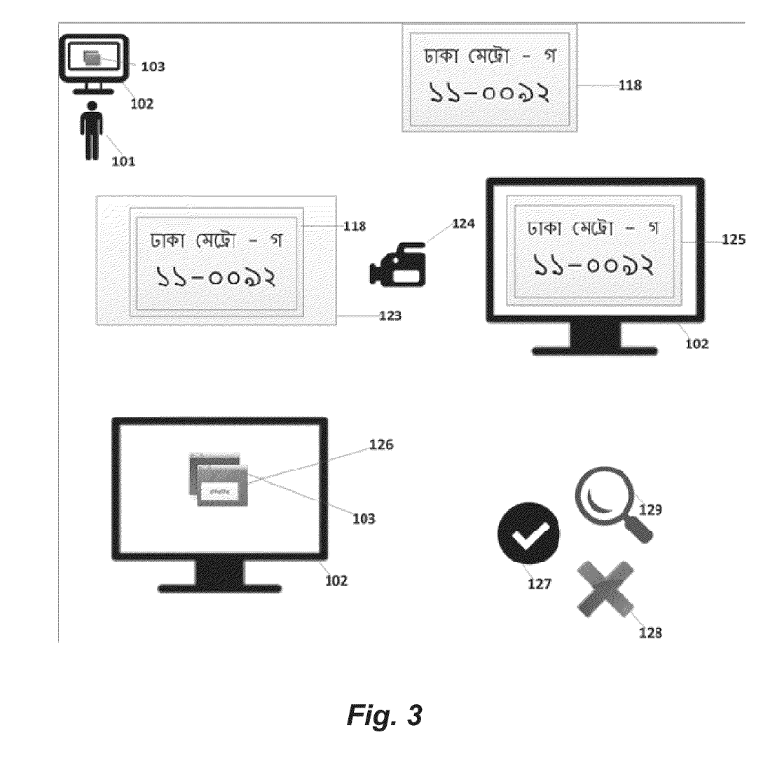

The final version is shown in the bottom right-hand corner of FIG. 2. Plate 118 is the final product of the license plate embossment process illustrated in FIG. 2. Upper character line 119 includes the region characters, the “-” character and the vehicle type characters with fonts that are now colored. Apertures 120, as they appear after hot stamping process 116, are shown. Lower character line 121 includes colored vehicle identifying characters and the “-” character after hot stamping 116. Furthermore, border 122 is now colored. The finished plate 118 is then passed through a quality assurance and verification workflow/process, as discussed in the context of FIG. 3.

FIG. 3 is an example block diagram of an overall quality assurance and verification process for a vehicle identification plate according to an example embodiment. User 101 is the operator as well as the quality assurance adjudicator who validates and/or verifies the license plates (as manufactured with the process described in the context of FIG. 2) with the given specifications by the system. Computer device 102 may be a client device that executes a client program for license plate quality assurance 103. Computer device 102 may be included in computer system 10 of FIG. 17. Plate 118 is the plate to be automatically analyzed for quality assurance and/or verified by the process shown in FIG. 3. In various embodiments, plate 118 was manufactured in a process similar to the process illustrated in FIG. 2.

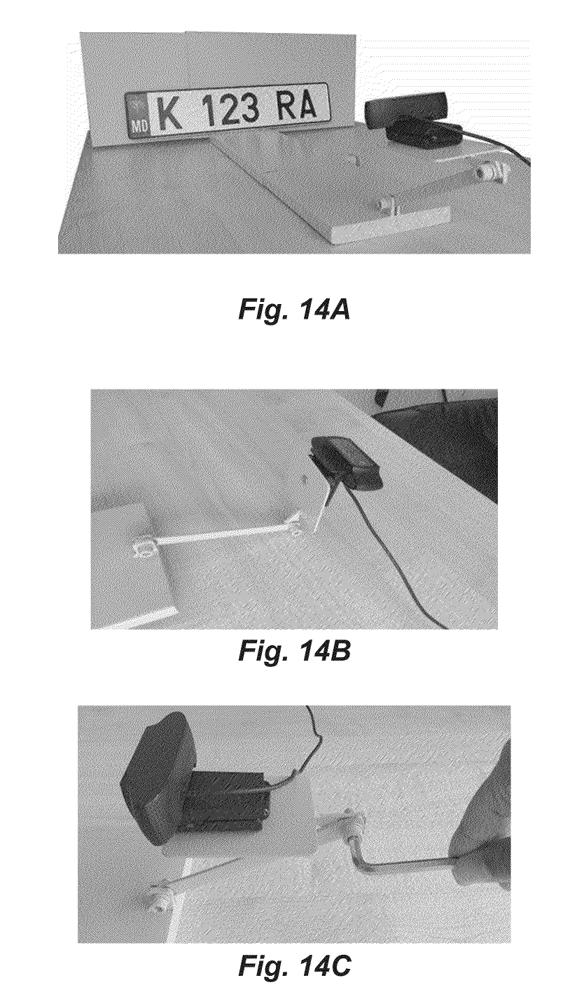

At the beginning of the quality assurance process illustrated in FIG. 3, plate 118 is positioned within frame 123. Prior to, or after plate 118 is positioned within frame 123, the plate's machine-readable barcode may be read. As mentioned above, when the barcode is read, the associated registration details are retrieved from a computer device or a registration database. Based on the retrieved registration data, the system determines the plate's size and color. At least a portion of this information is displayed on a display screen associated with client device 102, such as display 12 of FIG. 17. A user 101 of client device 102 may manually verify the color and size for the retrieved registration data. Frame 123 holds plate 118 to enable the capture of image data of plate 118. Frame 123 may be similar to at least one of the various embodiments illustrated in FIGS. 14A-16C. As described herein, the image data is automatically processed to verify the quality of manufactured plate 118.

Image sensor 124 captures image data of plate 118 held by frame 123. Image sensor 124 may be a camera such as a digital camera. Various examples of cameras include, but are not limited to cellphone cameras, handheld cameras, tablet cameras, web cams, cameras embed into computer devices, and the like. Virtually any image sensor may be employed for image sensor 124.

Image data and/or photographs captured with image sensor 124 are provided to computer device 102 and client program 103. The image data is used to validate the quality and/or correctness/accurateness of the manufactured plates against various quality assurance requirements. Image data 125, visually rendered by computer device 102, is an exemplary embodiment of a captured image of manufactured license plate 118. Client program 103 employs image data 125. Client program 103 performs image processing and pattern recognition processes to generate image templates of the characters embossed on the manufactured plates 118. Client program 103 may be included in Plate Quality Assurance System (PQAS), such as PQAS 100 of FIG. 17. These generated templates or canvas images are used in the overall validation procedure to determine whether the manufactured plate 118 meets the quality assurance requirements. In various embodiments, quality assurance requirements may include, but are not limited to requirements for correct plate color, character font and color, correct region and/or jurisdiction, vehicle type, and license plate digits, as illustrated by windows 126 of client program 103.

Upon determining whether plate 118 satisfies each of the various quality assurance requirements, user 101 and/or client program 103 may determine whether to approve or disapprove the manufactured license plate 118. For instance, if user 101 determines to accept plate 118, user 101 may select accept icon 127 within client program 103. Otherwise, user 101 may reject plate 118 by selecting reject icon 128, or decide to further manually inspect plate 118 by selecting search icon 129.

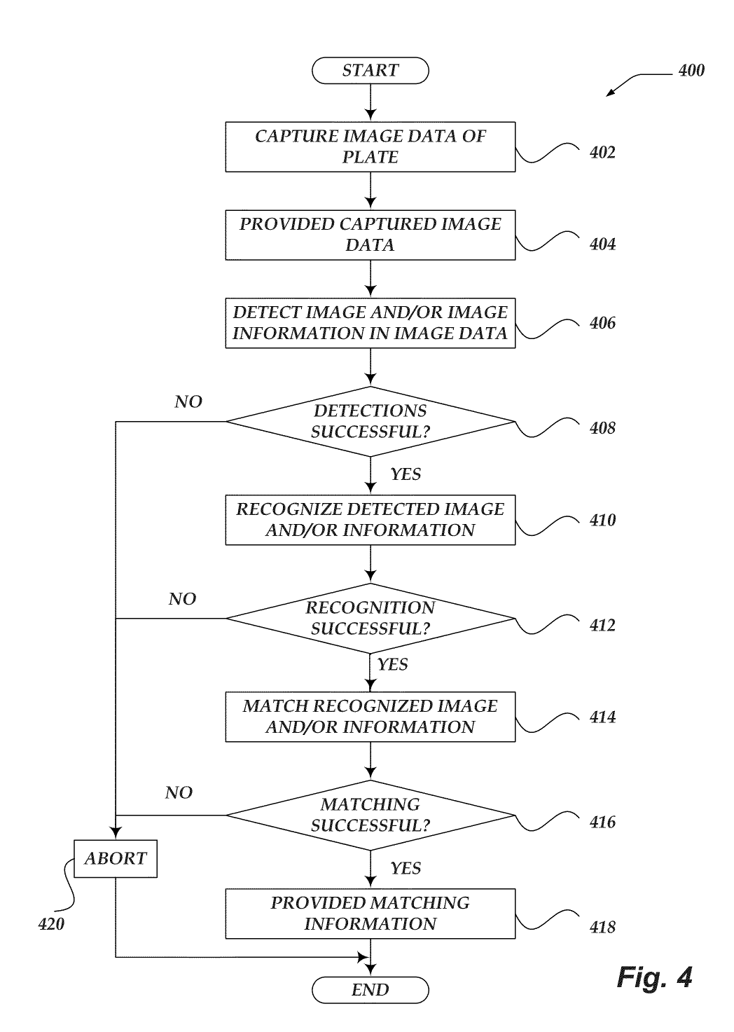

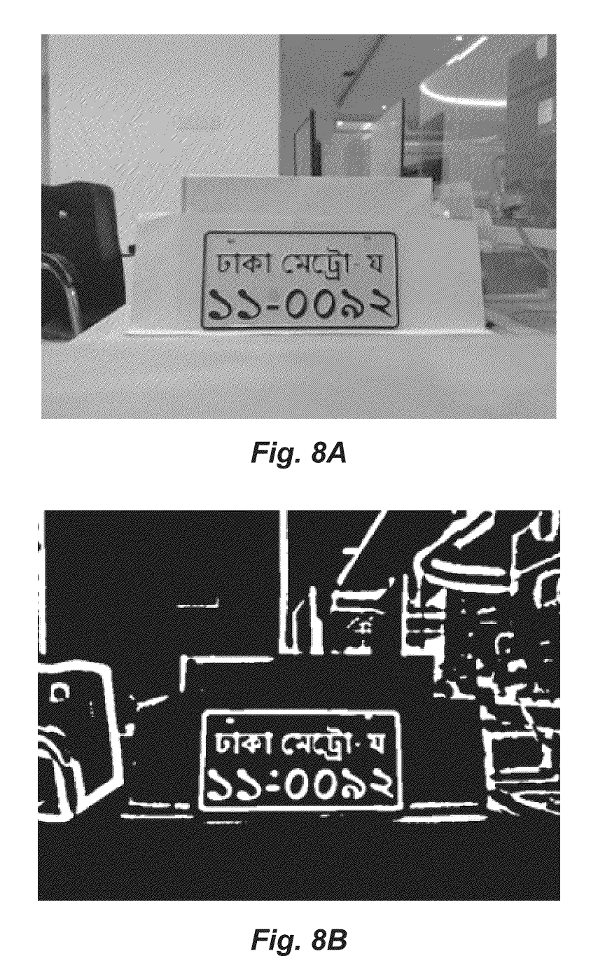

FIG. 4 is an example embodiment of an overall workflow 400 for the automatic verification and quality assurance for a vehicle identification plate consistent with the various embodiments disclosed herein. After a start block, workflow 400 proceeds to block 402, where image data of the plate to be verified and/or quality assured is captured. The image data may be captured in a similar manner to that described in the context of FIG. 3. In block 402, an image sensor, such as image sensor 124 of FIG. 3, captures the image data of the plate. In various embodiments, a frame, such as frame 123 of FIG. 2, holds and stabilizes the plate. FIG. 8A illustrates an example of image data taken at block 402. At block 404, the image data is provided to a computer device, such as computer device 102 of FIG. 3 or computer system 10 of FIG. 1. The computer device may be running a quality assurance program, such as client program 103 of FIG. 3 or PQAS 100 of FIG. 17.

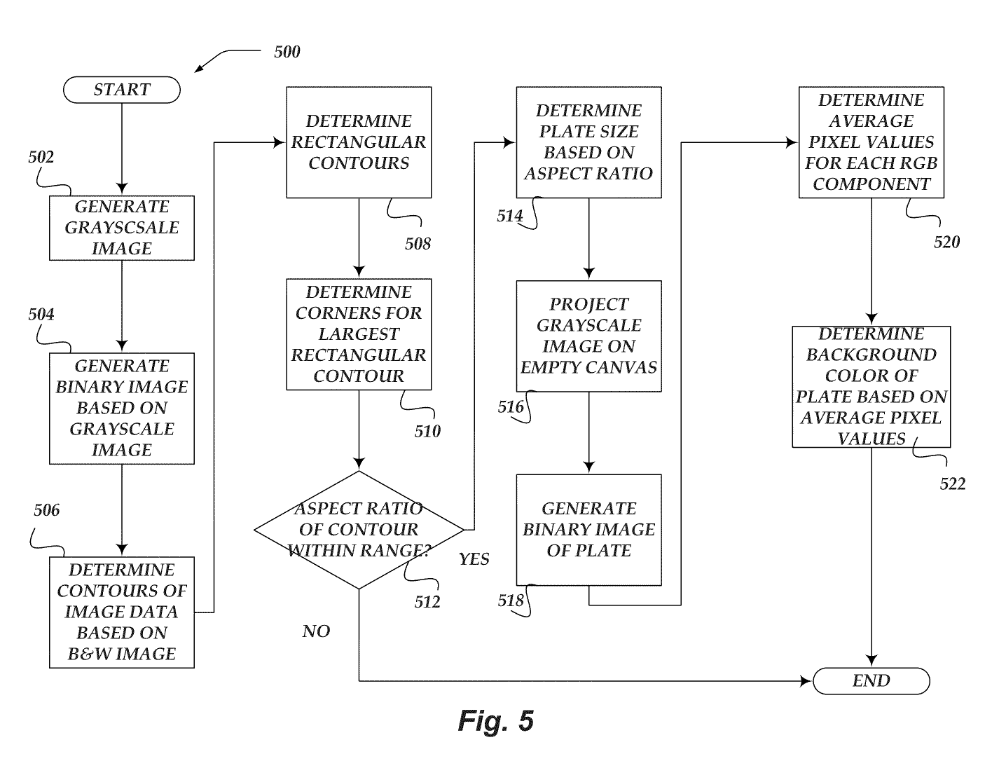

In block 406, various pieces of information, such as image information, are detected and/or extracted from the provided image data. Various embodiments of the detection of information from the image data are discussed in the context of FIG. 5. The information of the image data that is detected in block 406 may include, but is not limited to the size of the license plate, as well as the background color of the license plate. To briefly summarize, at block 406, the image data is cropped to include only the image data relevant to the verification and quality assurance of the license plate and a binary image is generated that corresponds to the image data that is associated with the license plate region within the image. The size and position of the license plate region within the image data is determined by locating contours within the image data. In various embodiments, the binary image data is black and white (B&W) image data.

At decision block 408, a determination is made whether the image and/or information was successfully determined at block 406. If the detections at block 406 are not successful, workflow 400 proceeds to block 420. At block 420, various warning and/or errors may be provided to a user, such as user 101 of FIG. 3 and workflow 400 is aborted. In at least one embodiment, the user may be enabled to capture additional image data and/or restart workflow 400. Otherwise, workflow 400 proceeds to the end block and is terminated.

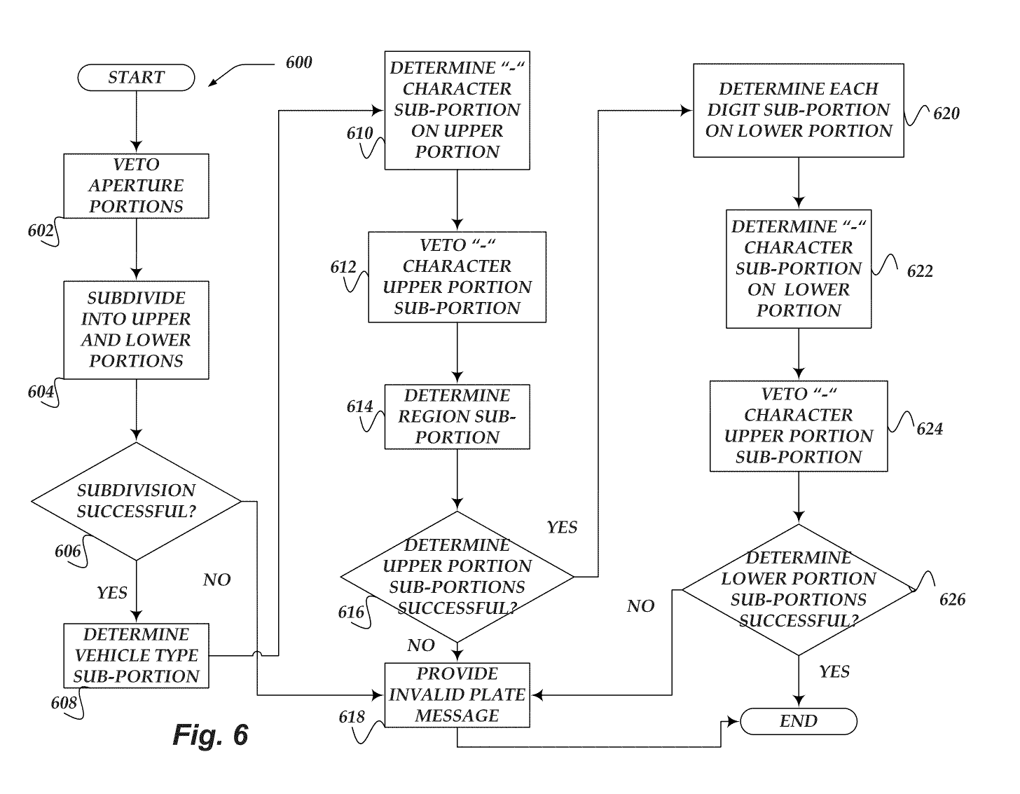

If the detections at block 406 were successful, workflow 400 proceeds to block 410. At block 410, the detected image and/or information is recognized. Various embodiments of the recognition of the detected image and/or information are discussed in the context of FIG. 6. However briefly, at block 410, the B&W image of the license plate area generated at block 406 is sub-divided, partitioned and/or cropped into several separate regions, each to be independently analyzed. For instance, the upper portion of the B&W license plate image data is sub-divided into a region or jurisdiction sub-portion, a vehicle type sub-portion and a “-” character sub-portion. Likewise, the lower portion is subdivided into license plate number character or digit sub-portions. As discussed in the context of FIG. 6, each of the sub-portions or areas is cropped so that the sub-portions are of the same dimension as the associated templates that are used for character recognition.

At decision block 412, a determination whether the detected image and/or information was successfully recognized at block 410. If the recognitions at block 410 are not successful, workflow 400 proceeds to abort block 420. Otherwise, workflow 400 proceeds to block 414.

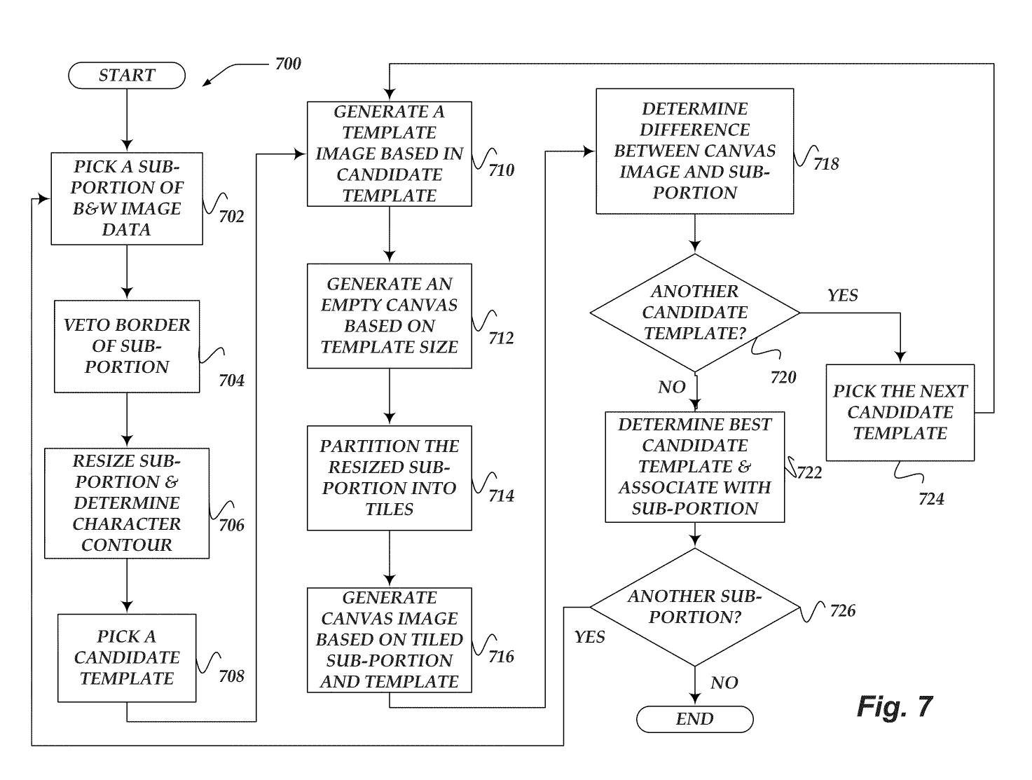

At block 414, the recognized image and/or information is matched. Various embodiments of the matching of the recognized image and/or information are discussed in the context of FIG. 7. However, briefly, each of the sub-portions determined in block 410 are separately analyzed to match character templates to the characters included in each of the sub-portions. Upon successfully matching each of the characters in each of the sub-portions, the characters embossed on the license plate are determined.

At decision block 416, a determination whether the recognized image and/or information was successfully matched at block 414. If the matchings at block 414 are not successful, workflow 400 proceeds to abort block 420. Otherwise, workflow 400 proceeds to block 418. At block 418, the matching results are provided to a user. For instance, the automatically recognized plate size, type, and color, as well as the vehicle type, registration number, and region may be returned by the process and provided to the user. Workflow 400 terminates at the end block.

FIG. 5 is an example process 500 for detecting an image and/or image information from image data that is consistent with various embodiments describe herein. At least a portion of process 500 may be employed at block 406 in FIG. 4. The image data may be image data captured in block 402 of FIG. 4. After a start block, and at block 502, a greyscale image of the image data is generated and saved. In a preferred embodiment, the green channel or component from the RGB components is extracted from the image data. Because in preferred embodiments, the background of the plate is either white or green, extracting the green channel is appropriate for license plates with either license plates background colors.

A block 504, binary image data is generated based on the grayscale image data. In preferred embodiments, the binary image data includes black and white (B&W) image data. Adaptive threshold techniques are employed to update the color of the pixels on the grayscale image generated in block 502 to generate a B&W image based on the image data. Adaptive thresholding may perform better in various lighting conditions, as compared to normal thresholding.

As described below, this generated B&W image is employed to determine the size of the plate within the image. The adaptive threshold techniques are based on the light intensity associated with different regions of the image. One such adaptive threshold technique may include generating a neighborhood window around each pixel in the greyscaled image data. The average intensity of each neighborhood is determined and is subtracted from the intensity of the center pixel of the neighborhood. If the result of this subtraction is greater than a predetermined intensity threshold, then the pixel is characterized as a white pixel (intensity value 255), otherwise, the pixel is characterized as a black pixel (intensity value 0). The predetermined intensity threshold may be based on the lighting conditions when the image data was captured. FIG. 8B shows an exemplary embodiment of one such B&W image generated by an adaptive threshold technique applied to the image data shown in FIG. 8A.

At block 506, at least a portion of the contours within the image are determined based on the B&W image. At block 508, the rectangular contours within the image data are determined, based on the contours found in the image data at block 506. To determine which of the contours within the B&W image are rectangular contours, a polygon approximation approach may be employed. For each of the contours, an inner contour is determined. For each determined inner contour, a polygon is approximated. Such a polygon approximation reduces the number of points that are required for consideration. For each inner contour, it is determined whether the inner contour is a rectangular contour based on analyzing the number of points associated with the approximating polygon and the relative position of the points in the polygon.

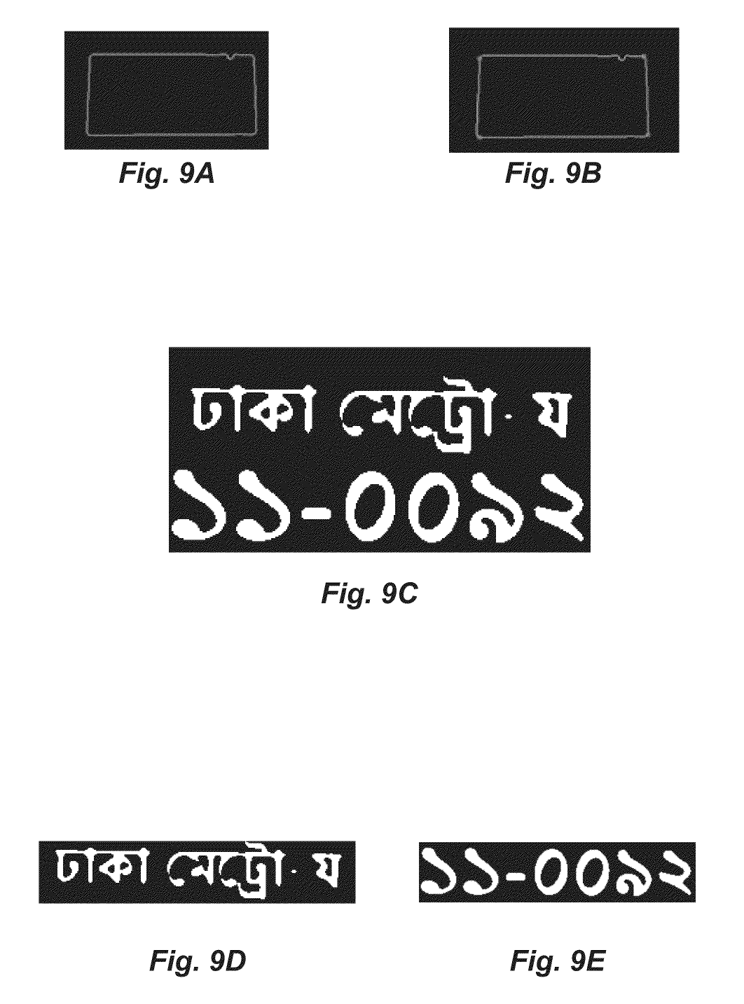

In block 510, the largest of the rectangular contours from block is determined. It is assumed that the largest rectangular contour corresponds to the license plate. The corners and size of the largest rectangular contour are determined. FIG. 9A shows the largest rectangular polygon/contour determined from the B&W image shown in FIG. 8B. The four corners, or bounding points, of the determined largest rectangular contour are determined. To determine the four corners of the largest rectangular contour, the B&W image is convolved with a horizontal line mask to find horizontal sides. For each horizontal side of the rectangular, an equation of the line is determined based on a regression line fitting. A similar process is employed for two vertical sides of the rectangle, wherein the mask is a vertical line mask. The crossing points of the determined four lines are used as the corner points of the license plate. FIG. 9B shows the determined four boundary points (corners) of the largest rectangular polygon/contour shown in FIG. 9A.

At decision block 512, it is determined whether the aspect ratio of the largest rectangular contour is within a predetermined aspect ratio range. The predetermined aspect ratio range may correspond to an expected range of aspect ratios that are substantially similar to that of the license plates to be verified and/or quality assured. If the aspect ratio does not fall within the predetermined range, it is assumed that the contour is not associated with the bounds of the plate. In the embodiment illustrated in FIG. 5, if the aspect ratio is not within the predetermined range, process 500 ends. In various embodiments, the user may be provided with an error message. In other embodiments, process 500 may discard the determined largest rectangular contour and loop back to block 510 to determine the largest rectangular contour after the previously determined contour has been discarded and/or vetoed from the analysis. This loop back may be continued until all the candidate rectangular contours have been discarded or a largest rectangular contour that is within the predetermined range is determined. If the aspect ratio is within the predetermined aspect ratio range, then process 500 proceeds to block 514.

At block 514, the size of the license plate is determined based on at least one of the aspect ratio or the four corners of the largest rectangular contour determined at block 510. At block 516, the grayscale image determined at block 502 is projected on an empty canvas. A perspective transformation matrix is generated to snap the candidate contour to a plate sized canvas. The size of the projection and/or empty canvas is determined based on the plate size determined in block 514. This transformation is applied on the generated grayscale image of block 502. The license plate region is extracted and/or cropped from the grayscale image.

At block 518, a binary image of the license plate image region extracted at block 516 is generated. To generate a binary image of the extracted license plate region, a global threshold technique is applied to the relevant portion of the transformed grayscale plate image. Applying the global threshold technique converts the background pixels into black pixels and character pixels into white pixels. The threshold value is determined dynamically to compensate for varying contrast in the transformed image. In at least one embodiment, Otsu's method is employed to determine the threshold value. In computer vision and image processing, Otsu's method is used to automatically perform clustering-based image thresholding, or the reduction of a gray-level image to a binary image. In typical application, the algorithm assumes that the image contains two classes of pixels following bi-modal histogram (foreground pixels and background pixels), then calculates the optimum threshold separating the two classes so that their combined spread (intra-class variance) is minimal. The global threshold technique is used because the contrast is assumed stable across the extracted plate image. FIG. 9C shows a B&W image of the extracted license plate region, where the Otsu method has been applied to perform the global thresholding.

At block 520, the average pixel value for at least the Red component of the RGB components or channels of the relevant portion (as determined in block 510) is determined. In various embodiments, an average pixel value is determined for each RGB component is determined. As block 522, the background color of the plate is determined based on the determined average pixel values determined at block 520. For instance, in preferred embodiments, if the average pixel value of the red components is less than a predetermined red component threshold, then the background color of the license plate is green. Otherwise, the background color of the license plate is white. Process 500 terminates at the end block.

FIG. 6 is an example process 600 for recognizing detected image and/or image information from image data that is consistent with various embodiments describe herein. Process 600 may be employed at block 410 in FIG. 4. The image data may be image data captured in block 402 of FIG. 4. In a preferred embodiment, the binary, or B&W, image of the license plate portion of the image data generated at block 408 of FIG. 4 is provided as an input for process 600. After a start block, and at block 602, a the portion of the B&W license plate image data that corresponds to the mounting holes or apertures is vetoed and/or discarded.

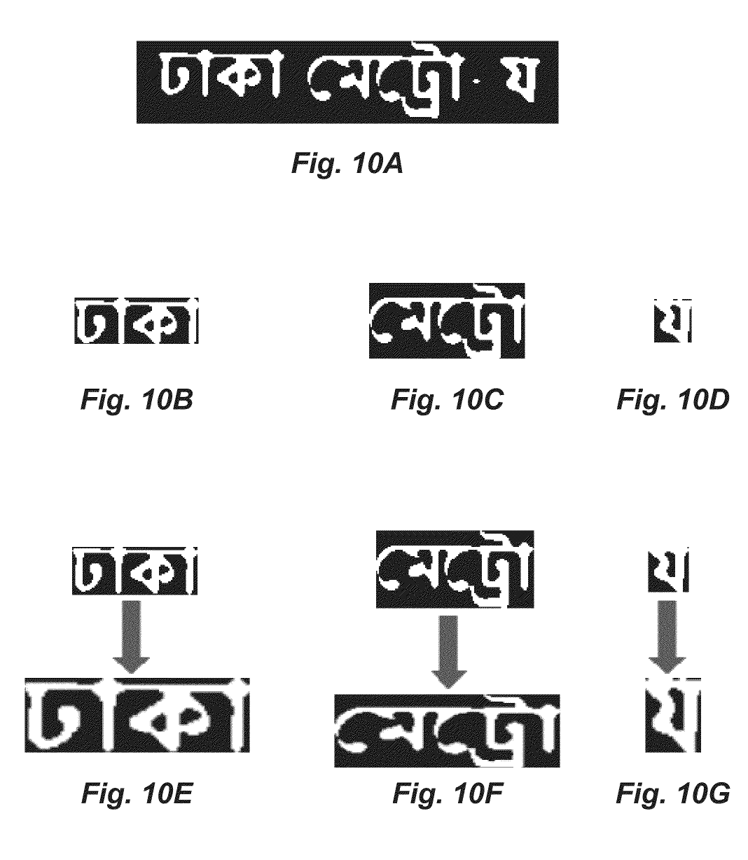

At block 604, the B&W image data of the plate region is subdivided into at least two separate portions: (a) an upper portion that includes character information indicating the region (or jurisdiction) and the vehicle type and (b) a lower portion that includes character information indicating the license plate numbers. In at least one embodiment, the upper portion includes a larger vertical height than the lower portion. FIG. 10A illustrates an upper portion of the B&W image data of the license plate portion of the image data.

At decision block 606, it is determined if the subdivision of block 604 was successful. If the subdivision was not successful, then process 600 proceeds to block 618. At block 618, an invalid plate message is provided to a user. If the subdivision was successful, then process 600 proceeds to block 608.

The upper portion of the B&W image data is sub-divided into sub-portions or regions, where each sub-portion indicates one of the region (or jurisdiction), the “-” character, or the vehicle type. At block 608, the sub-portion indicating the vehicle type is determined by a pixel scanning process. Beginning at the rightmost white pixel and moving from right to left in the upper portion, vertical lines of pixels are scanned. The vertical scanning continues until reaching the first vertical line of all black pixels after a first vertical line of white pixels is scanned. A similar scanning process is performed by horizontally scanning, from top to bottom, the sub-portion found by the vertical scanning process. From the top of the sub-portion, horizontal scanning continues until the first horizontal line of all black pixels after a first horizontal line of white pixels is determined. The process assumes the horizontal distance between the vehicle type character and the “-” character is equivalent to the minimum space between two separate words. The vehicle type sub-portion is cropped or extracted from the B&W image data. 10D illustrates an extracted sub-portion of B&W image data that indicates the vehicle type and is cropped from the upper portion shown in FIG. 10A.

At block 610, a similar pixel scanning process determines the “-” character sub-portion of the upper portion. At block 612, the determined “-” character sub-portions are vetoed and/or discarded from process 600. At block 614, the sub-portion indicating the region or jurisdiction is determined by a similar pixel scanning process. Again moving from left to right, this time beginning with the first vertical line of all black pixels to the left of the identified “-” character, the sub-portion is vertically scanned. The vertical scanning continues until the first vertical line of all black pixels after a first vertical line of white pixels. Similar to the horizontal process for the vehicle type sub-portion, a horizontal scanning process is performed. In this way, the sub-portion that includes the rightmost character identifies the region or jurisdiction is identified. This process is continues to identify more sub-portions that include characters identifying the region or jurisdiction. Between each horizontal separation of characters, it is determined if the horizontal space of black pixels is the same or greater than the horizontal distance corresponding to a “SPACE” character. If so, a space between separate words is identified. The region or jurisdiction sub-portion is cropped or extracted from the B&W image data. In some embodiments, if two separate words are identified, two separate sub-portions are cropped. For instance, FIG. 10B illustrates an extracted sub-portion that indicates the first word of the region or jurisdiction. FIG. 10 A illustrates the extracted sub-portion that indicates the second word of the region or jurisdiction. Both sub-portions in FIGS. 10B and 10C are cropped from the upper portion shown in FIG. 10A.

At decision block 616, it is determined if the subdivision of the upper portion into two or more sub-portions was successful. If the subdivision was not successful, then process 600 proceeds to block 618. If the subdivision was successful, then process 600 proceeds to block 608.

At block 620, a scanning process is carried out for the lower portion of the plate that includes characters corresponding to the license plate number. Thus, each of the sub-portions that identify the region or jurisdiction, the vehicle type, and the license plate number are identified. Block 620 determines a sub-portion for each character or digit in the license plate number portion of the plate B&W image data. As with block 610, block 622 determines sub-portions in the lower portions that indicate a “-” character. Block 624 vetoes, or discards, the determined “-” character sub-portions of the lower portions.

At decision block 626, it is determined if the subdivision of the lower portion into two or more sub-portions that include license plate digits was successful. If the subdivision was not successful, then process 600 proceeds to block 618. If the subdivision was successful, then process 600 terminates.

FIG. 7 is an example process 700 for matching recognized image and/or image information that is consistent with various embodiments describe herein. Process 700 may be employed at block 414 in FIG. 4. The image and/or image information may be recognized in block 410 of FIG. 4. In a preferred embodiment, the various sub-portions of image data are provided as an input for process 700. After a start block, and at block 702, one of the sub-portions of the B&W license plate image data is picked for analysis. For example, one of the region/jurisdiction sub-portion, the vehicle type sub-portion, or one of the license plate number sub-portions are picked. At block 704, the border of the sub-portion is vetoed, cropped, or otherwise excluded from the analysis.

At block 706, the sub-portion is resized to fit a standard template size. The standard template size may be based on a subset of candidate template included in a template database. The size may be based on the type of sub-portion to be analyzed. The resizing is performed so that the borderless sub-portions are of the same dimensions as the candidate templates employed in the analysis. For instance, FIGS. 10E and 10F illustrates the resizing of the first and second words in the region or jurisdiction sub-portions shown in FIGS. 10B and 10C respectively. Likewise, FIG. 10G illustrates the resizing of the vehicle type sub-portion that is shown in FIG. 10D.

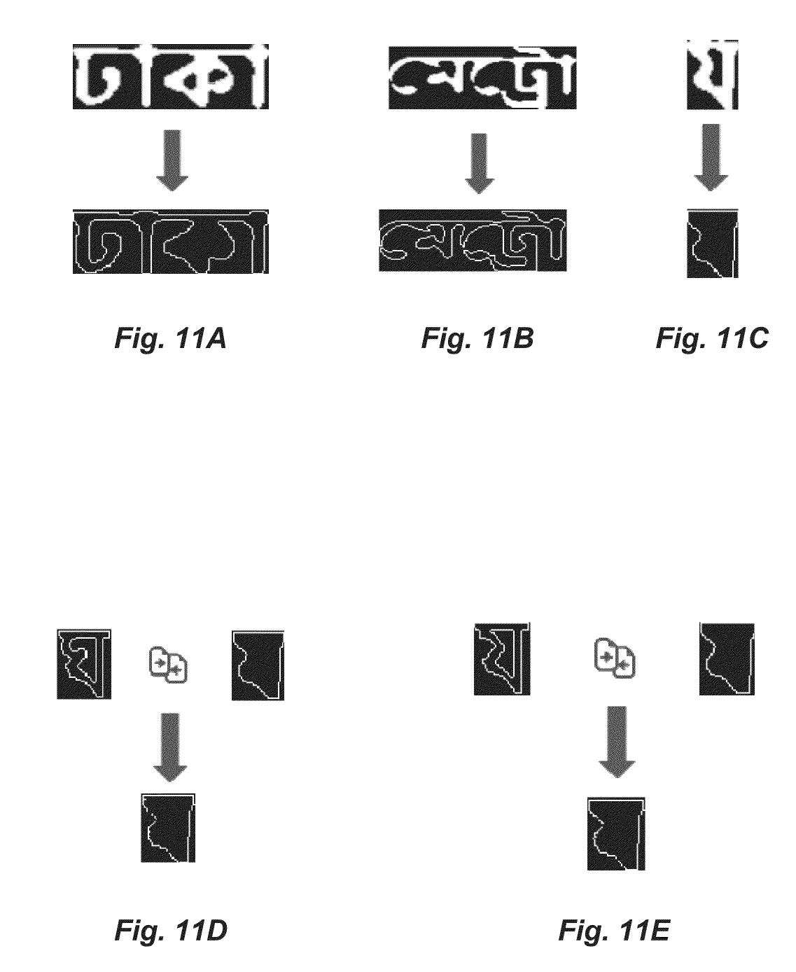

Next, the contours for each of the resized sub-portion are determined. FIGS. 11A and 11B illustrate the contours for the first word and second word in the region/jurisdiction sub-portion respectively. Likewise, FIG. 11C illustrates the determined contours for the vehicle type sub-portion. As described further below, these contours are compared to each of the relevant character templates in the template database. For each comparison, a canvas image, or new template, is generated. The template that generates the minimum difference between the canvas image and the template is associated with the character and/or character string corresponding to the contour in the sub-portion. In this way, each of the characters that are embossed on the license plate is recognized and/or determined. From this determination, the license plate is verified that it includes the correct information.

At block 708, a candidate template is picked. The candidate template may be picked from the template database. The candidate template may be based on the type of sub-portion being analyzed by process 700. Accordingly, the search space for character recognition may be limited by using different templates for recognizing region, vehicle type, and license plate numbers. For instance, there are only 67 possible license plate regions in Bangladesh. Additionally, there are a finite number of vehicle types embossed onto license plated in Bangladesh.

At block 710, an image of the candidate template is generated. At block 712, an empty canvas, or new template, is generated based on the candidate template. The empty canvas may be sized to correspond to the template size. At block 714, an image of the resized contours, determined at block 706 is partitioned into a predetermined number of tiles.

At block 716, a canvas image is generated in the empty canvas generated at block 712. The generated image may be a new template. The generated canvas image may be based on the tiled image of the contours in the sub-portion being analyzed. In at least one embodiment, the canvas image is based on the candidate template. A “motion compensation”-like approach may be used to generate the new canvas image. To generate the new image, each tile of the tiled contours of the sub-portion may be determined and/or estimated by a comparison of the corresponding or neighboring region in the candidate template. The determined or estimated tile may then be placed in the corresponding region of the canvas that contains the canvas image being generated. In this way, the canvas image is generated tile-by-tile based on a comparison between the contours being analyzed and the candidate template.

As an example embodiment, FIG. 11D shows the generation of a canvas image based on the contours of the vehicle type region, extracted from the license plate image data, and a candidate template. The upper right portion of FIG. 11D shows that contours of a vehicle type sub-portion. The contour corresponds to the character string “Ja”. The upper left portion shows a candidate template that corresponds to the character string “Gha”. The bottom portion of FIG. 11D shows the canvas image, or new template, generated based on the comparison of the “Gha” template to the “Ja” contour. Likewise, FIG. 11E illustrates the generation of a canvas image based on a comparison of a contour of a “Ja” character string extracted from the license plate image data to a candidate template that corresponds to a “Ja” character string.

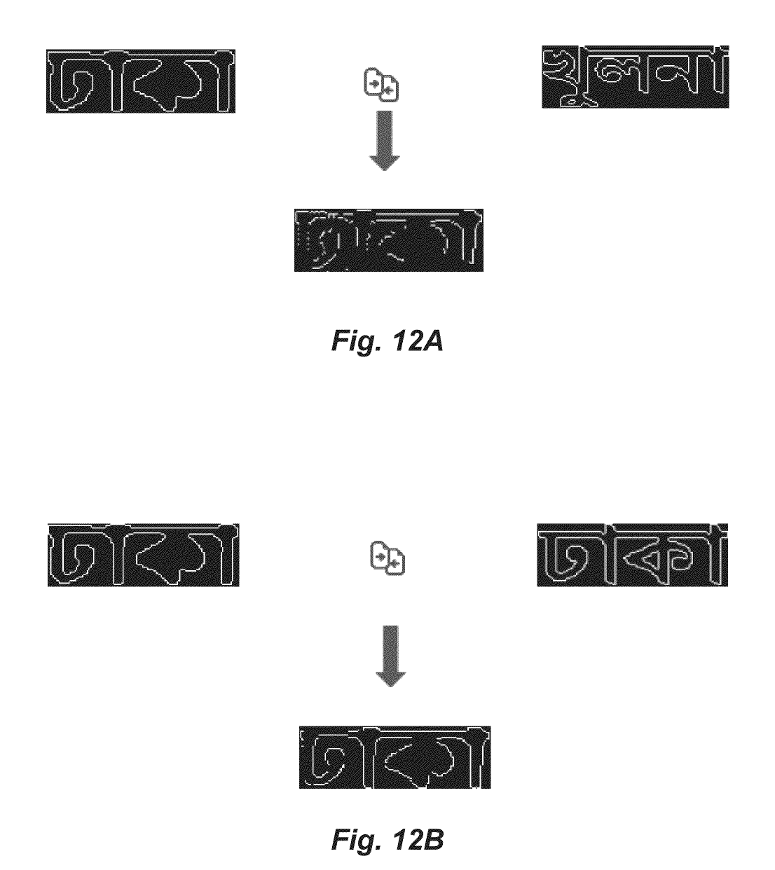

For an exemplary embodiment of the analysis carried out for region and/or jurisdiction sub-portion of the license plate image data, see FIGS. 12A-12B. FIG. 12A illustrates the generation of a canvas image based on a comparison of a contour corresponding to a “Dhaka” character string extracted from the region sub-portion of the license plate image data to a candidate template that corresponds to a “Khulna” character string. Likewise, FIG. 12B illustrates the generation of a canvas image based on a comparison of a contour corresponding to a “Dhaka” character string extracted from the region sub-portion of the license plate image data to a candidate template that corresponds to a “Dhaka” character string.

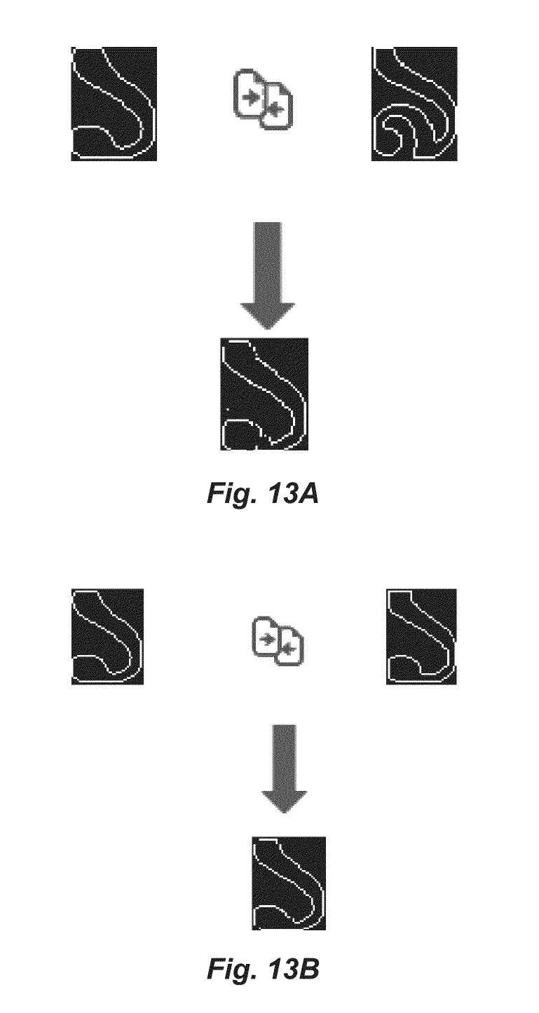

For an exemplary embodiment of the analysis carried out for a single digit of the license plate sub-portion of the license plate image data, see FIGS. 13A-13B. FIG. 13A illustrates the generation of a canvas image based on a comparison of a contour corresponding to a “Ek” character string (English translation: “1”) extracted from the license plate number sub-portion of the license plate image data to a candidate template that corresponds to a “Noi” character string (English translation: “9”). Likewise, FIG. 12B illustrates the generation of a canvas image based on a comparison of a contour corresponding to an “Ek” character string extracted from the license plate number sub-portion of the license plate image data to a candidate template that corresponds to an “Ek” character string.

At block 718, the difference between the canvas image and the sub-portion being analyzed is determined. This difference is based on a comparison between the canvas image and the image of the contours being analyzed. In at least one embodiment, the difference is determined on a pixel-by-pixel basis. At decision block 720, it is determined whether another relevant candidate template exists in the template database. If another candidate template exists, process 700 proceeds to block 724, where the next candidate template is picked. Process 700 then loops back to block 710.

If another candidate template does not exist, then process 700 proceeds to block 722. At block 722, the template that generates the minimum difference, as determined at block 718, is determined. This determination may be made by a comparison of each of the differences determined at block 718. This “best” template is then associated with the sub-portion. For instance, at block 722, in reference to FIGS. 11D and 11E, the template “Ja” template of FIG. 11E would be determined the as the template with the best fit. Accordingly, the characters associated with the sub-portion being analyzed would be assigned the “Ja” character string. Likewise, in a comparison between FIGS. 12A and 12B, the “Dhaka” template of FIG. 12B would be the best-fit template. In a comparison of FIGS. 13A and 13B, the “Ek” template of FIG. 13B would be the best-fit template.

At decision block 726, it is determined whether another sub-portion is to be analyzed. If so, process 700 loops back to block 702 to pick another sub-portion to be analyzed. If no other sub-portions are to be analyzed, process 700 ends.

### Example Embodiment of a Stabilizing Frame for Capturing Image Data

FIG. 14A shows one embodiment of a frame assembly specifically adapted to hold and stabilize a license plate, as well as an image sensor device. The frame enables capturing image data, such as the image data captured in block 402 of FIG. 4 or as described in the context of FIG. 3. As shown in FIG. 14A, the frame assembly is specially adapted to hold an object, such as a Bangladesh license plate, as well as the image sensor employed to capture image data of the license plate. FIG. 14B illustrates an adjustable arm that the image sensor in mounted to. The adjustable arm enables the camera to be adjusted to a position in order to get an accurate orthogonal projection of the plate. The adjustability of the arm enables the adjustment of the position, both the longitudinal and the vertical height positions, as well as the angle of the image sensor relative to the license plate. FIG. 14C illustrates a user adjusting and locking the position of the adjustable arm, wherein the image sensor is coupled to the adjustable arm. Locking the position enables stabilizing the camera at an optimum distance to capture image data of plates of all sizes and models.

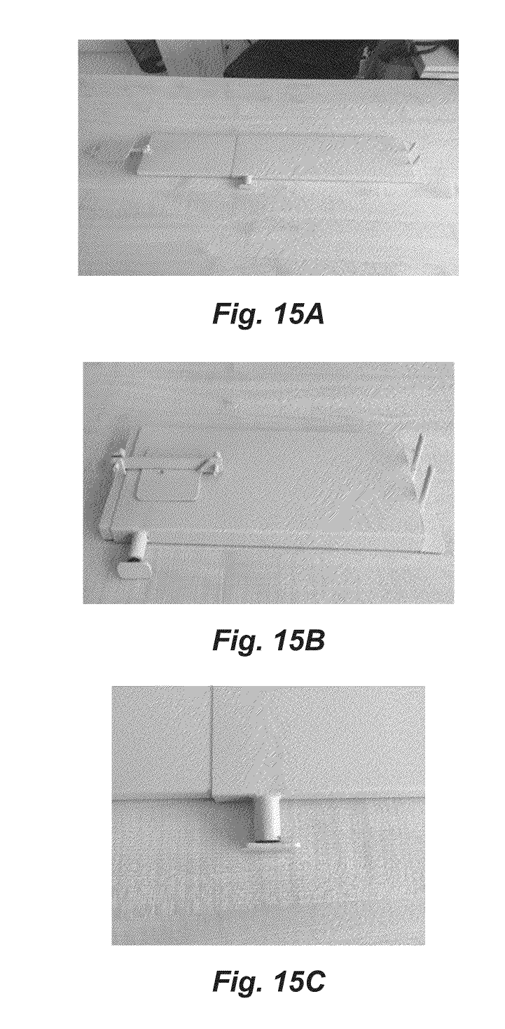

In various embodiments, the frame includes a base sub-assembly and a platform that couples to the base sub-assembly and holds the license plate. The platform is discussed in the context of FIGS. 15A-15C. FIG. 15A shows a preferred embodiment of a base sub-assembly. The base sub-assembly may be a folding sub-assembly for convenient transportation and storage. As shown in FIG. 15A, the base sub-assembly unfolds into a substantially flat base. Coupled to one longitudinal end are the adjustable arm and a sub-base to hold and adjust the positioning of the image sensor. On the other longitudinal end are at least two prong-like fasteners to couple the platform to the base assembly.

FIG. 15B illustrates the base sub-assembly in a folded orientation. FIG. 15C shows a close-up view of a key assembly. In preferred embodiments, when in the unfolded orientation of FIG. 15A, the base sub-assembly is a telescoping base sub-assembly, such that the longitudinal distance between the adjustable arm and the fasteners coupling the platform to the base is variable by telescopically translating at least two base members towards or away from each other. The key assembly locks or otherwise stabilizes the adjustable longitudinal distance when engages.

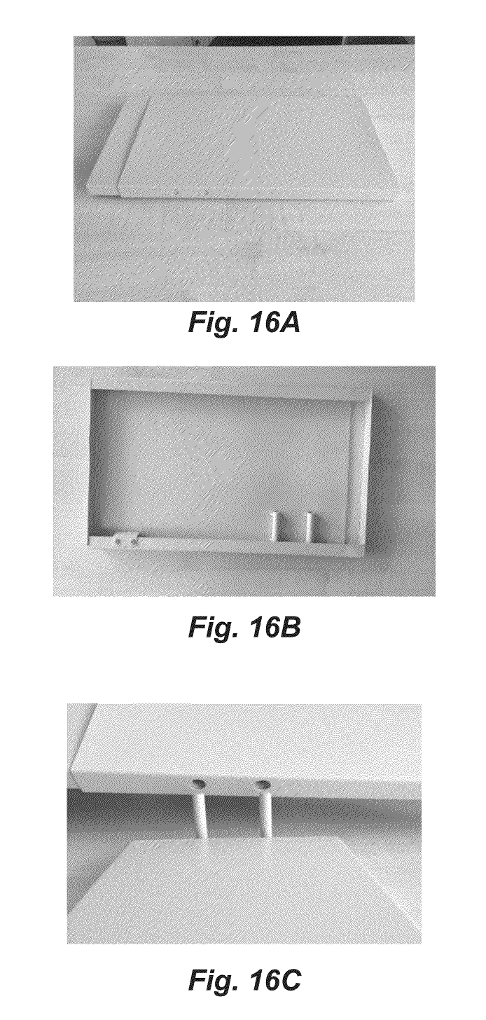

FIG. 16A illustrates the top side of the platform that couples to the base sub-assembly of FIGS. 15A-15C. In a preferred embodiment, the platform is a telescoping platform to adjust a lateral width of the platform based on a width of the license plate to be verifies or otherwise quality assured. At least two fasteners receive or otherwise mate with the prong-like fasteners of the sub-assembly as shown on a side of the platform. FIG. 16B shows the backside of the telescoping platform. Note that the fasteners are shown in detail from the backside. FIG. 16C shows the coupling of the platform with the base sub-assembly. When fully assembled and holding a license plate and an image sensor, various embodiments of the frame appear similar to the view shown in FIG. 14A.

The frame is designed to be used with virtually any image sensor. Both the distance and the height are adjustable as can be seen from FIGS. 14A-15C. Camera from different vendors can be fit onto the panel and the height can be elevated or reduced depending on the requirements. Each component is foldable and comes in a very small package to reduce shipping costs. It supports different plate sizes and dimensions as can be seen from the picture. The frame increases accuracy of image capture and processing because of the horizontal and/or vertical adjustment of the position of the plate and the camera. This helps to reduce reflection from overhead lighting especially in factory environments. Also, the frame supports different plate sizes and dimensions.

Various embodiments include a plurality of colored shapes to enable a position calibration of the system. For instance, a preferred embodiment includes four small colored shapes at four corners of the backdrop. In q calibration window, same shapes will be drawn at preferred position over a captured image. The user may adjust the camera position in such a way that shapes on the supporting bar and shapes on a captured image overlay and are aligned. This auto validation will be done to ensure position calibration is in place during photo capture.

While positioning a plate on the frame, captured image data may be blurred and the characters may be distorted due to motion. Blurring may result in unsatisfactory feature detection. To mitigate and/or minimize image blur, various embodiments include motion detection technique.

For instance, the absolute difference between successive images may be determined pixel by pixel. This difference image is then compared against a predefined threshold value T. If intensity of all the pixels (of difference image) are below T, then the later frame is considered stable. If K consecutive frames are stable, then the last frame is selected for further processing.

Due to various possible lighting conditions (fluorescent/colored light) in a quality assurance environment, which may affect the detection of the plate color and/or font color. To compensate for affects based on ambient light color/temperature, various embodiments include a user interface control (in calibration window) to adjust system parameters based on ambient lighting conditions. Captured image data may be preprocessed according an adjustable control value to reduce lighting effects on plate image.

In various embodiments, the frame increases the accuracy of image data capture because the frame positions the plate vertically. The vertical orientation reduces reflection form overhead lighting when capturing the image data. This placement also results in a favorable angle of orientation between the image sensor and the license plate.

### Example Computing System Implementation

FIG. 17 is an example block diagram of an example computing system for implementing a Plate Quality Assurance System (PQAS) according to an example embodiment. In particular, FIG. 17 shows a computing system 10 that may be utilized to implement a PQAS 100. In addition, at least some of the implementation techniques described herein with respect to the PQAS 100 may be used to implement other devices, systems, or modules described herein. Any of the processes, methods, algorithms, and the like disclosed herein may be implements in PQAS 100. For instance, at least any of the processes described in the context of FIG. 2 through FIG. 7 may be enabled by at least PQAS 100.

Note that one or more general purpose or special purpose computing systems/devices may be used to implement the PQAS 100. In addition, the computing system 10 may comprise one or more distinct computing systems/devices and may span distributed locations. Furthermore, each block shown may represent one or more such blocks as appropriate to a specific embodiment or may be combined with other blocks. In addition, the PQAS 100 may be implemented in software, hardware, firmware, or in some combination to achieve the capabilities described herein.

In the embodiment shown, computing system 10 comprises a computer memory (“memory”) 11, a display 12, one or more Central Processing Units (“CPU”) 13, Input/Output devices 14 (e.g., keyboard, mouse, CRT or LCD display, and the like), other computer-readable media 15, and network connections 16. The PQAS 100 is shown residing in memory 11. In other embodiments, some portion of the contents, some or all of the components of the PQAS 100 may be stored on and/or transmitted over the other computer-readable media 15. The components of the PQAS 100 preferably execute on one or more CPUs 13 and perform the techniques described herein. Other code or programs 30 (e.g., an administrative interface, a Web server, and the like) and potentially other data repositories, such as data repository 20, also reside in the memory 11, and preferably execute on one or more CPUs 13. Of note, one or more of the components in FIG. 4 may not be present in any specific implementation. For example, some embodiments may not provide other computer readable media 15 or a display 12.

The PQAS 100 is shown executing in the memory 11 of the computing system 10. Also included in the memory are a user interface manager 41 and an application program interface (“API”) 42. The user interface manager 41 and the API 42 are drawn in dashed lines to indicate that in other embodiments, functions performed by one or more of these components may be performed externally to the PQAS 100.

The UI manager 41 provides a view and a controller that facilitate user interaction with the PQAS 100 and its various components. For example, the UI manager 41 may provide interactive access to the PQAS 100, such that users can interact with the PQAS 100. In some cases, users may configure the operation of the PQAS 100, such as by providing the PQAS 100 credentials to access various information sources, including social networking services, email systems, document stores, or the like. In some embodiments, access to the functionality of the UI manager 41 may be provided via a Web server, possibly executing as one of the other programs 30. In such embodiments, a user operating a Web browser executing on one of the client devices 50 can interact with the PQAS 100 via the UI manager 41.

The API 42 provides programmatic access to one or more functions of the PQAS 100. For example, the API 42 may provide a programmatic interface to one or more functions of the PQAS 100 that may be invoked by one of the other programs 30 or some other module. In this manner, the API 42 facilitates the development of third-party software, such as user interfaces, plug-ins, adapters (e.g., for integrating functions of the PQAS 100 into Web applications), and the like.

In addition, the API 42 may be in at least some embodiments invoked or otherwise accessed via remote entities, such as code executing on one of the client devices 50, information sources 60, and/or one of the third-party systems/applications 55, to access various functions of the PQAS 100. For example, an information source 60 may push license plate and/or template information (e.g., a database including candidate templates or registration information regarding manufactured licenses plates) to the PQAS 100 via the API 42. The API 42 may also be configured to provide management widgets (e.g., code modules) that can be integrated into the third-party applications 55 and that are configured to interact with the PQAS 100 to make at least some of the described functionality available within the context of other applications (e.g., mobile apps).

The PQAS 100 interacts via the network 99 with client devices 50, information sources 60, and third-party systems/applications 55. The network 99 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The third-party systems/applications 55 may include any systems that provide data to, or utilize data from, the PQAS 100, including Web browsers, e-commerce sites, calendar applications, email systems, social networking services, and the like.

In an example embodiment, components/modules of the PQAS 100 are implemented using standard programming techniques. For example, the PQAS 100 may be implemented as a “native” executable running on the CPU 13, along with one or more static or dynamic libraries. In other embodiments, the PQAS 100 may be implemented as instructions processed by a virtual machine that executes as one of the other programs 30. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. In addition, other functions could be implemented and/or performed by each component/module, and in different orders, and by different components/modules, yet still achieve the described functions.

In addition, programming interfaces to the data stored as part of the PQAS 100, such as in the data stores 116 and/or 20, can be available by standard mechanisms such as through C, C++, C#, and Java APIs; libraries for accessing files, databases, or other data repositories; through scripting languages such as XML; or through Web servers, FTP servers, or other types of servers providing access to stored data. The data stores 116 and/or 20 may be implemented as one or more database systems, file systems, or any other technique for storing such information, or any combination of the above, including implementations using distributed computing techniques.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in some embodiments, some or all of the components of the PQAS 100 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications, non-patent publications, and appendixes referred to in this specification and/or listed in the Application Data Sheet are incorporated herein by reference, in their entirety.

From the foregoing it will be appreciated that, although specific embodiments have been described herein for purposes of illustration, various modifications may be made without deviating from the spirit and scope of this disclosure. For example, the methods, techniques, and systems for the automatic verification and quality assurance of plates are applicable to other architectures or in other settings. Also, the methods, techniques, and systems discussed herein are applicable to differing protocols, communication media (optical, wireless, cable, etc.) and devices (e.g., desktop computers, wireless handsets, electronic organizers, personal digital assistants, tablet computers, portable email machines, game machines, pagers, navigation devices, etc.).

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for verifying information imprinted on a plate, the method comprising:
capturing image data, wherein the image data includes a plate region that corresponds to the plate;
generating a first binary image based on the plate region;
partitioning at least a portion of the first binary image into at least one sub-portion;
determining at least one contour associated with the sub-portion of the first binary image;
associating a matching template to the contour based on a comparison of the contour to a plurality of candidate templates; and
determining at least a portion of the information imprinted on the plate based on the associated matching template.

2. The method of claim 1, further comprising:
generating a second binary image based on the image data;
determining a largest rectangular contour included in the second binary image, wherein the largest rectangular contour includes an aspect ratio within a predetermined aspect ratio range; and
determining the plate region based on the largest rectangular contour.

3. The method of claim 1, further comprising:
updating a size of the sub-portion based on a standard template size;
partitioning the updated sub-potion into a plurality of tiles;
generating a canvas image for each of the plurality of candidate templates based on a comparison between each of the plurality of tiles and a corresponding region in each of the candidate templates; and
determining a difference between each canvas image and the sub-portion, wherein the matching template corresponds to a minimum difference of the determined differences.

4. The method of claim 1, further comprising determining a background color of the plate based on an average pixel value of the plate region.

5. The method of claim 1, further comprising determining a plate size based on an aspect ratio of a largest rectangular contour included in the image data.

6. The method of claim 1, wherein partitioning the portion of the first binary image includes partitioning the first binary image into at least one of a region sub-portion, a vehicle type sub-portion, and a plate number sub-portion.

7. The method of claim 1, further comprising:
determining a sub-portion type of the sub-portion based on a location of the sub-portion within the first binary image; and
determining the plurality of candidate templates based on the sub-portion type.

8. The method of claim 1, further comprising:
comparing at least a portion of the determined information imprinted on the plate to information included in a database; and
vetoing the plate when the compared portion of information imprinted on the plate does not correspond to the information included in the database.

9. A non-transitory computer-readable medium including contents that, when executed by a computing system, facilitate verifying information imprinted on a plate, by performing a method comprising:
receiving image data, wherein the image data includes a plate region that corresponds to the plate;
generating a first binary image based on the plate region;
partitioning at least a portion of the first binary image into at least one sub-portion;
determining at least one contour associated with the sub-portion of the first binary image;
associating a matching template to the contour based on a comparison of the contour to a plurality of candidate templates; and
determining at least a portion of the information imprinted on the plate based on the associated matching template.

10. The computer-readable medium of claim 9, the method further comprising:
generating a second binary image based on the image data;
determining a largest rectangular contour included in the second binary image, wherein the largest rectangular contour includes an aspect ratio within a predetermined aspect ratio range; and
determining the plate region based on the largest rectangular contour.

11. The computer-readable medium of claim 9, the method further comprising:
updating a size of the sub-portion based on a standard template size;
partitioning the updated sub-potion into a plurality of tiles;
generating a canvas image for each of the plurality of candidate templates based on a comparison between each of the plurality of tiles and a corresponding region in each of the candidate templates; and
determining a difference between each canvas image and the sub-portion, wherein the matching template corresponds to a minimum difference of the determined differences.

12. The computer-readable medium of claim 9, wherein partitioning the portion of the first binary image includes partitioning the first binary image into at least one of a region sub-portion, a vehicle type sub-portion, and a plate number sub-portion.

13. The computer-readable medium of claim 9, the method further comprising:
determining a sub-portion type of the sub-portion based on a location of the sub-portion within the first binary image; and
determining the plurality of candidate templates based on the sub-portion type.

14. The computer-readable medium of claim 9, the method further comprising:
comparing at least a portion of the determined information imprinted on the plate to information included in a database; and
vetoing the plate when the compared portion of information imprinted on the plate does not correspond to the information included in the database.

15. The computer-readable medium of claim 9, wherein the determined information imprinted on the plate includes at least one of a region, a vehicle type, or a plate number encoded in a conjunct character string.

16. A computing system configured to facilitate verifying information imprinted on a plate, the system comprising
a processor device;
a memory device;
a module that is stored by the memory device and that is configured, when executed by the processor device, to:
receive image data, wherein the image data includes a plate region that corresponds to the plate;
generate a first binary image based on the plate region;
partition at least a portion of the first binary image into at least one sub-portion;
determine at least one contour associated with the sub-portion of the first binary image;
associate a matching template to the contour based on a comparison of the contour to a plurality of candidate templates; and
determine at least a portion of the information imprinted on the plate based on the associated matching template.

17. The computing system of claim 16, the module further configured to:
generate a second binary image based on the image data;
determine a largest rectangular contour included in the second binary image, wherein the largest rectangular contour includes an aspect ratio within a predetermined aspect ratio range; and
determine the plate region based on the largest rectangular contour.

18. The computing system of claim 16, the module further configured to:
update a size of the sub-portion based on a standard template size;
partition the updated sub-potion into a plurality of tiles;
generate a canvas image for each of the plurality of candidate templates based on a comparison between each of the plurality of tiles and a corresponding region in each of the candidate templates; and
determine a difference between each canvas image and the sub-portion, wherein the matching template corresponds to a minimum difference of the determined differences.

19. The computing system of claim 16, the module further configured to:
determine a sub-portion type of the sub-portion based on a location of the sub-portion within the first binary image; and
determine the plurality of candidate templates based on the sub-portion type.

20. The computing system of claim 16, the module further configured to:
compare at least a portion of the determined information imprinted on the plate to information included in a database; and
veto the plate when the compared portion of information imprinted on the plate does not correspond to the information included in the database.
